(19) United States
(12) Patent Application Publication
(10) Pub. No.: US 2026/0163862 A1
(43) Pub. Date: Jun. 11, 2026

(54) ROLE DETERMINATION IN A NETWORK ADDRESS ASSIGNMENT PROCESS

(71) Applicant: HEWLETT PACKARD ENTERPRISE DEVELOPMENT LP, Spring, TX (US)

(72) Inventors: Rajib Majila, Bangalore (IN); Ram Lakhan Patel, Bangalore (IN)

(21) Appl. No.: 19/071,918

(22) Filed: Mar. 6, 2025

(30) Foreign Application Priority Data
Dec. 11, 2024 (IN) 202441098109

(51) Int. Cl. H04L 61/5014

(52) U.S. Cl. CPC H04L 61/5014

(57) ABSTRACT

In some examples, a server provides a network address assignment service for compute entities to assign network addresses to the compute entities. The server receives a first message including an indicator for a compute entity, the first message being part of a network address assignment process for the compute entity, and the indicator informing the server that the server is to assign a role to the compute entity for implementing a role-based policy. The server determines, based on detecting the indicator, the role of the compute entity. The server sends, as a response to the first message, a second message containing a role field specifying the role of the compute entity.

### BACKGROUND

Compute entities are able to communicate with one another or to access resources in a network environment. The compute entities can be divided into multiple groups according to roles of the compute entities. Group-based policies can be applied at enforcement points in the network environment.

### BRIEF DESCRIPTION OF THE DRAWINGS

Some implementations of the present disclosure are described with respect to the following figures.

FIG. 1 is a block diagram of an arrangement including network switches and a Dynamic Host Configuration Protocol (DHCP) server, according to some examples.

FIG. 2 is a flow diagram of a process involving a compute entity, a network switch, and a DHCP server, according to some examples.

FIG. 3 is a block diagram of a storage medium storing machine-readable instructions according to some examples.

FIG. 4 is a block diagram of a network device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Group-based policies that are applied with respect to respective groups of compute entities can control the manner in which the compute entities are able to communicate in a network environment, what resources are accessible by the compute entities, actions that may be taken by the compute entities, or other aspects of the compute entities. To determine which group a particular compute entity is to be assigned, a role of the particular compute entity is determined. Group-based policies can be used to perform segmentation within the network environment to control data traffic patterns across or within groups of compute entities. In some cases, to determine which group-based policy to apply, a source role and a destination role are determined as data packets are communicated across a network. The source role is the role of a source compute entity that transmitted a data packet, and the destination role is the role of a destination compute entity that is the target of the data packet. A group-based policy that is according to a role (or a combination of roles) can also be referred to as a role-based policy.

In some examples, a role of a compute entity can be determined during an authentication process performed by the compute entity with an authentication server to authenticate the compute entity. The authentication process may be according to the Institute of Electrical and Electronics Engineers (IEEE) 802.1X standards. Role information for the compute entity can be provided by the authentication server, such as a Remote Authentication Dial-In User Service (RADIUS) server. A network device, such as a switch, uses the role information set by the authentication server to map the role of the compute entity to a network address of the compute entity. However, in some cases, compute entities may not perform authentication processes with an authentication server. For example, a network environment may not specify that compute entities are to follow a port access policy that indicates use of an authentication process when a compute entity seeks access to a network. If an authentication process is not performed by a compute entity seeking access to a network, then a role of the compute entity may not be produced. If the role of the compute entity is not available, then an application of a role-based policy for the compute entity may not be possible. The inability to apply a role-based policy for the compute entity can raise security issues or may mean that the compute entity would not be able to operate or communicate in a computing environment.

In accordance with some implementations of the present disclosure, a role is assigned to a compute entity during a network address assignment process by a network address assignment server. In some examples of the present disclosure, the network address assignment server receives a first message including a role assignment indicator for a compute entity that is to be assigned a network address. In some examples, the network address assignment server is a Dynamic Host Configuration Protocol (DHCP) server for assigning Internet Protocol (IP) addresses to compute entities. In such examples, the first message can be a DHCP Discover message. The first message is part of the network address assignment process for the compute entity. The role assignment indicator informs the network address assignment server that the network address assignment server is to assign a role to the compute entity for implementing a group-based policy (or equivalently, a role-based policy). The network address assignment server determines, based on detecting the role assignment indicator, a role of the compute entity. The network address assignment server sends, as a response to the first message, a second message containing a role field specifying the role of the compute entity. An example of the second message is a DHCP Offer message.

In some examples of the present disclosure, the role assignment indicator is added to the first message by a network device that intercepted the first message from the compute entity. For example, the network device may perform snooping of messages relating to network address assignment processes (e.g., DHCP snooping). The second message sent by the network address assignment server in response to the first message is targeted to the compute entity. However, the network device intercepts the second message and extracts the role field from the second message to determine the role of the compute entity. The role of the compute entity is added by the network device to an entry of network address mapping information, where the entry correlates the role to a network address of the compute entity. The network device can remove the role field from the second message, and the network device sends the second message without the role field to the compute entity to continue the network address assignment process.

In some examples, the assignment of roles during network address assignment processes may be transparent to compute entities, i.e., the compute entities do not have to be configured to support role assignment during the network address assignment processes. This transparency is achieved by network devices intercepting certain network address assignment messages (e.g., DHCP Discover and DHCP Offer messages) and modifying these intercepted network address assignment messages as part of role assignments in network address assignment processes. In such examples, compute entities are not aware that the network devices are participating in the role assignments during network address assignment processes.

Techniques or mechanisms according to some examples of the present disclosure improve computer functionality or the relevant technology of network communications by supporting an efficient way to assign roles to compute entities in network address assignment processes so that segmentation of a network environment can be achieved to provide for isolation of traffic of compute entities, implement security mechanisms, or other functionalities. By assigning roles to compute entities in network address assignment processes, systems do not have to rely on compute entity authentication processes for assigning roles to compute entities. Additionally, in some examples, role-based policies are not installed in hardware of a network device until the network device detects the role(s) associated with the role-based policies. In this way, resources of the hardware of the network device are not wasted by installing role-based policies for roles that have not yet been encountered.

By assigning roles to compute entities during network address assignment, the roles of the compute entities can be determined prior to the compute entities actually communicating data packets over a network. This can avoid any delays associated with attempting to determine the role of a compute entity after network communications with the compute entity have begun. Also, the determination of roles of compute entities in network assignment processes can be made transparent to the compute entities, so that the compute entities do not have to be reconfigured to support role identification during network assignment processes.

A “compute entity” can refer to an electronic device, such as a computer, a smartphone, an Internet-of-Things (IoT) device, a game appliance, a headset, a vehicle, a household appliance, or any other type of electronic device. A “compute entity” can also refer to a virtual compute entity, such as a virtual machine (VM), a container, or another type of virtual compute entity.

A “role” of a compute entity can refer to a property (or properties) of the compute entity, and/or of a user of the compute entity. For example, a role of the compute entity can include any or some combination of the following: a guest role (indicating that the compute entity is associated with a user that is visiting the network environment), a role of a specific department within an organization (indicating that the compute entity belongs to a user that works in the specific department), a responsibility or assigned function of the compute entity, a capability of the compute entity, or any other characteristic of the compute entity.

A network device forwards data packets of compute entities, such as according to network address mapping information stored at the network device. The network device can include any or some combination of the following: a switch, a router, an access point (AP), a gateway, or any other type of network device.

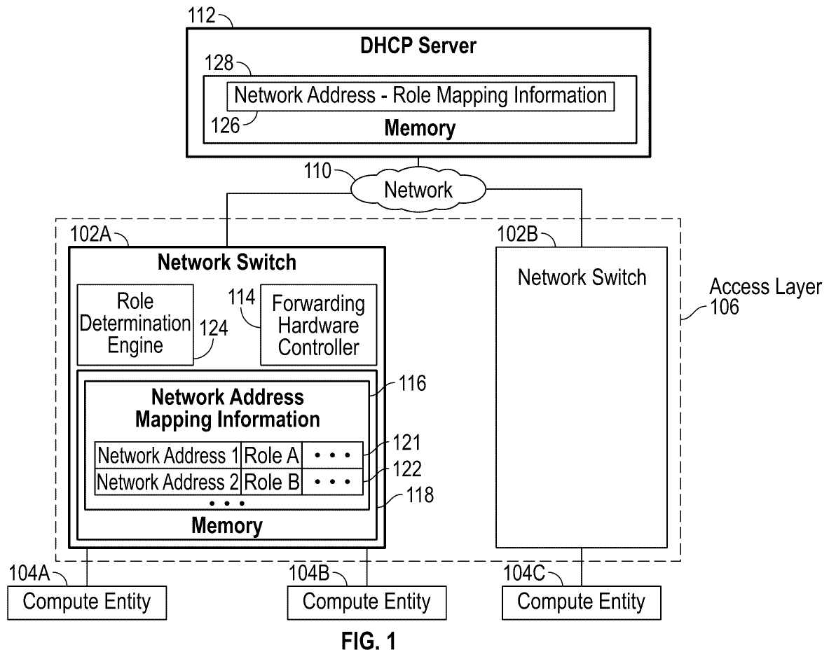

FIG. 1 is a block diagram of an example network environment that includes various network switches 102A and 102B to which are connected compute entities 104A, 104B, and 104C. Each network switch can be connected to one or more compute entities. In the depicted example, the compute entities 104A and 104B are connected to the network switch 102A, and the compute entity 104C is connected to the network switch 102B. Although specific quantities of compute entities and network switches are shown in FIG. 1, in different examples, a different quantity of network switches and/or a different quantity of compute entities may be present. FIG. 1 shows components inside the network switch 102A. A similar arrangement of components may be present in the network switch 102B.

The network switches 102A and 102B are part of an access layer 106 through which the compute entities 104A, 104B, and 104C can communicate with other endpoints. Each network switch can forward data packets (or more simply “packets”) among different endpoints. Forwarding a packet can refer to performing layer 2 switching of the packet based on a Media Access Control (MAC) address (or other types of layer 2 network addresses), or layer 3 routing based on Internet Protocol (IP) addresses (or other types of layer 3 network addresses).

In some examples, the forwarding of packets can be performed by a forwarding hardware controller 114. In a specific example, the forwarding hardware controller 114 can include a Content-addressable Memory (TCAM) hardware controller, which is a hardware component for accelerating the process of forwarding packets by quickly matching network addresses to corresponding entries in network address mapping information 116 stored in a memory 118. In the depicted example, the memory 118 is outside the forwarding hardware controller 114. In other examples, the memory 118 may be part of the forwarding hardware controller 114. In further examples, instead of using the forwarding hardware controller 114 such as a TCAM hardware controller, the network switch 102A can forward packets using machine-readable instructions executed by a processing resource of the network switch 102A.

The network switches 102A and 102B are also connected to a network 110. A DHCP server 112 is also connected to the network 110. The network 110 can include a local area network (LAN), a wide area network (WAN), a public network, or any other type of network. In accordance with some examples of the present disclosure, the DHCP server 112 is able to assign roles to compute entities in DHCP processes. Although just one DHCP server is shown in FIG. 1, in other examples, there may be multiple DHCP servers.

In some examples, the network address mapping information 116 can include a MAC address table or an Address Resolution Protocol (ARP) table (or both the MAC address table and the ARP table). The forwarding hardware controller 114 can use the MAC address table to forward switched traffic, and the forwarding hardware controller 114 can use the ARP table for forwarding routed traffic. Switched traffic includes a data packet that contains a destination MAC address used for identifying a network path over which the network switch 102A is to forward the data packet. Routed traffic includes a data packet containing source and destination IP addresses used for determining a network path for forwarding the data packet. In routed traffic, the ARP table is used to perform a lookup of a destination MAC address corresponding to a destination IP address, so that the obtained destination MAC address can be used for forwarding a data packet based on the MAC address table.

The network address mapping information 116 includes entries 121 and 122 (as well as other entries). Each entry correlates a network address to other information, including role information that specifies a role. For example, an entry of a MAC address table can correlate the following information: a MAC address, role information, information of a physical interface of a network switch to which a packet is to be forwarded if the packet contains the MAC address in the entry, and possibly other information. An entry of an ARP table can correlate the following information: an IP address, a MAC address, role information, and possibly other information.

By including role information in entries of the network address mapping information 116, the network switch 102A is able to identify a role of a compute entity based on the network address of the compute entity. For example, the entry 121 correlates network address 1 to role A, and the entry 122 correlates network address 2 to role B. As an example, if a data packet received from a given compute entity contains network address 1, then a lookup of the network address mapping information 116 based on network address 1 retrieves the entry 121, and the network switch 102A can identify role A as being the role of the given compute entity.

In accordance with some examples of the present disclosure, the network switch 102A includes a role determination controller 124 to determine a role of a compute entity during a network address assignment process, such as a DHCP process. The role determination controller 124 determines the role of the compute entity based on a message exchange between the network switch 102A and the DHCP server 112. The DHCP server 112 stores network address-role mapping information 126 in a memory 128 of the DHCP server 112. The DHCP server 112 uses the network address-role mapping information 126 to correlate a network address (e.g., a MAC address) to a respective role during a DHCP process. The DHCP process dynamically assigns an IP address to a compute entity based on the MAC address of the compute entity.

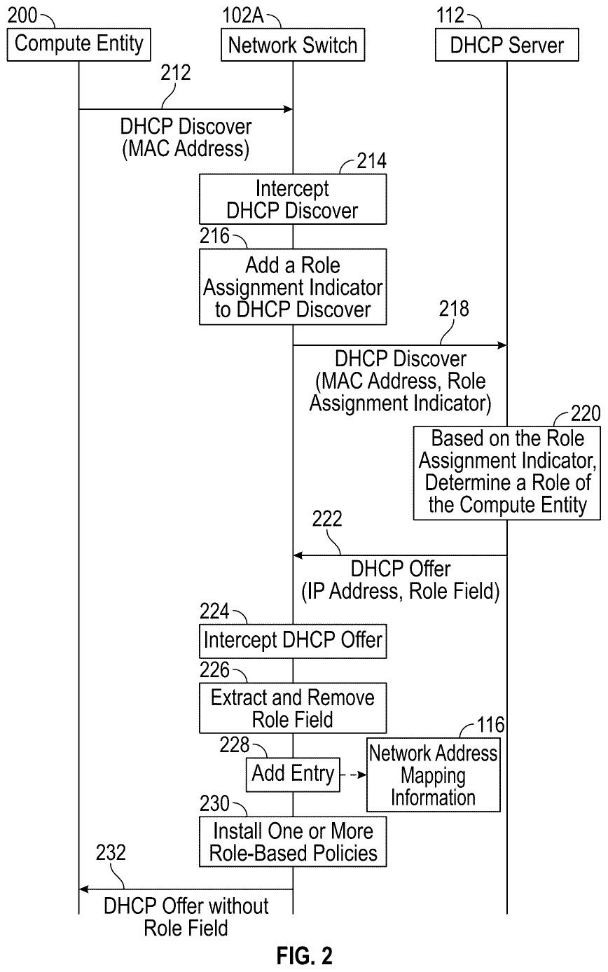

FIG. 2 is a is a flow diagram of a process involving a compute entity 200, the network switch 102A, and the DHCP server 112. The compute entity 200 can be the compute entity 104A, 104B, or 104C of FIG. 1. In other examples, a similar process can be performed by other compute entities, network switches, and/or DHCP servers.

To begin a DHCP process, the compute entity 200 broadcasts (at 212) a DHCP Discover message. The DHCP Discover message is sent by the compute entity 200 over a network to locate any available DHCP server on the network. The DHCP Discover message contains a MAC address of the compute entity 200. The network switch 102A can perform DHCP snooping of the DHCP messages sent by or targeted to compute entities, including the compute entity 200. As part of the DHCP snooping, the network switch 102A intercepts (at 214) the DHCP Discover message. After intercepting the DHCP Discover message, the role determination controller 124 (FIG. 1) in the network switch 102A adds (at 216) a role assignment indicator to the DHCP Discover message. The role assignment indicator is to inform the DHCP server 112 that the DHCP server 112 is to assign a role to the compute entity 200 for implementing a role-based policy.

In some examples, the role assignment indicator is in the form of a vendor class identifier (VCI) in the DHCP Discover message being set to a specified value. The VCI is referred to as DHCP option 60, as described in Request for Comments (RFC) 2132, “DHCP Options and BOOTP Vendor Extensions,” dated March 1997. The VCI (DHCP option 60) can be used to indicate a configuration of a DHCP client (in this case the compute entity 200). If the VCI is set to the specified value (e.g., “AssignRole” or any other predefined value), that provides an indication to the DHCP server 112 that a role is to be assigned to the DHCP client during a DHCP process.

A VCI is defined by a “vendor,” which refers to any entity that provides or develops equipment or programs used in network communications. Different vendors can define different VCIs.

The network switch 102A broadcasts (at 218) the DHCP Discover message containing the MAC address of the compute entity 200 and the role assignment indicator. In the example of FIG. 2, the DHCP Discover message is received by the DHCP server 112.

Based on detecting the role assignment indicator in the DHCP Discover message, the DHCP server 112 performs a lookup of the network address-role mapping information 126 (FIG. 1) to determine (at 220) a role of the compute entity 200. The lookup of the network address-role mapping information 126 uses the MAC address included in the DHCP Discover message to retrieve an entry of the network address-role mapping information 126. The retrieved entry contains role information that identifies the role corresponding to the MAC address of the compute entity 200.

The DHCP server 112 sends (at 222) a DHCP Offer message that is targeted to the compute entity 200. The DHCP Offer message includes a role field containing the role information obtained from the network address-role mapping information 126. Additionally, the DHCP Offer message contains an IP address selected by the DHCP server 112 from available IP addresses, where the selected IP address is assigned to the compute entity 200.

In some examples of the present disclosure, the role field included in the DHCP Offer message can be in a vendor-specific information option (DHCP option 43 as described in RFC 2132). DHCP option 43 is used by DHCP clients and servers to exchange vendor-specific information. Multiple information items may be encoded in the vendor-specific information. In such examples, the multiple information items are sub-option types, and each information item may have a specified length. A new sub-option type can be defined within DHCP option 43 to carry the role field. The multiple information items may include respective type-length-value (TLV) encoded items. Each TLV encoded item has a type element to indicate the type of information encoded in the TLV encoded item. A given TLV encoded item of the TLV encoded items has an assigned role type to indicate that the value (of a specified length) in the given TLV encoded item contains the role field. Stated differently, this given TLV encoded item containing the role field is a sub-option of DHCP option 43.

As part of the DHCP snooping performed by the network switch 102A, the network switch 102A intercepts (at 224) the DHCP Offer message. The role determination controller 204 in the network switch 202 extracts and removes (at 226) the role field in the DHCP Offer message.

The role determination controller 124 adds (at 228) an entry to the network address mapping information 116 (FIG. 1) in the network switch 102A. If the network address mapping information 116 is a MAC address table, the added entry correlates the MAC address of the compute entity 200 to the role information contained in the role field in the DHCP Offer message. If the network address mapping information 208 is an ARP table, the added entry correlates the IP address of the compute entity 200 to the role information contained in the role field in the DHCP Offer message.

If this is the first time that the network switch 102A has encountered the role specified by the role field, the network switch 102A also dynamically installs (at 230), in the forwarding hardware controller 114 (FIG. 1) of the switch 102A, one or more role-based policies that correspond to the role of the compute entity 200. Dynamically installing a role-based policy in the forwarding hardware controller 114 can refer to installing the role-based policy in response to detecting a role that is associated with the role-based policy. Prior to detecting the role, the role-based policy is not installed to conserve resources of the forwarding hardware controller 114.

After a role-based policy is installed in the forwarding hardware controller 114, the forwarding hardware controller 114 can enforce the role-based policy based on a source role (of a source compute entity) and a destination role (of a destination compute entity). The source compute entity is the entity that transmits a data packet, and the destination compute entity is the entity that is the target of the data packet.

The network switch 102A sends (at 232) the DHCP Offer message with the role field removed to the compute entity 200. In response to the DHCP Offer message, the compute entity 200 can continue with the DHCP process. For example, in response to the DHCP Offer message, the compute entity 200 can send a DHCP Request message (not shown) to the DHCP server 112, which responds with a DHCP Ack message (not shown).

Installing a role-based policy can include adding an entry to role-policy mapping information in the forwarding hardware controller 114. The added entry correlates a combination of roles to a respective role-based policy.

In an example, the role of the compute entity 200 specified in the role field of the DHCP Offer message may be role X. Table 1 below includes role-based policies correlated to role combinations in which role X is the destination role.

TABLE 1

| Source Role | Destination Role | Role-based Policy |
|---|---|---|
| A | X | Policy 1000 |
| B | X | Policy 3000 |
| F | X | Policy 7000 |

A “role combination” includes a combination of a source role and a destination role. In the above example, policy 1000 is correlated to the combination of source role A and destination role X, policy 3000 is correlated to the combination of source role B and destination role X, and policy 7000 is correlated to the combination of source role F and destination role X.

In the above example, if the role of the compute entity 200 indicated in the role field of the DHCP Offer message is role X, then the network switch 102A can install policies 1000, 3000, and 7000 into the forwarding hardware controller 114, since any of these policies may potentially be applied at the network switch 102A depending on the source role indicated by a data packet received by the network switch 102A.

The network switch 102A can provide role X to a remote management system to seek any role-based policies that are relevant to role X. The remote management system can send the role-based policies to the network switch 102A to install in the forwarding hardware controller 114.

The above example assumes that policy enforcement is performed at an egress network switch on a data packet received from an ingress network switch. The ingress network switch is the network switch to which a source compute entity (that transmitted the data packet) is connected. The egress network switch is the network switch to which a destination compute entity (that is the target of the data packet) is connected. The data packet can include a role tag identifying the source role of the source compute entity. Using the role tag, the egress network switch can determine the source role of the source compute entity. The egress network switch can further determine the role of the destination compute entity based on the network address of the destination compute entity, such as based on the network address mapping information 116 of FIG. 1. Using the combination of the source role and the destination role, the egress network switch applies a role-based policy to the data packet.

In some examples, the role tag in a data packet can be included in a header of the data packet. In examples where virtual tunnels according to the Virtual Extensible Local Area Network (VXLAN) protocol are used to communicate data packets between switches (such as the ingress and egress switches), the role tag can be included in a VXLAN header of the data packet.

According to the VXLAN protocol, virtual tunnels referred to as VXLAN tunnels can be established between virtual tunnel endpoints (VTEPs) to communicate data. The VTEPs can be provided in switches, for example. A VXLAN tunnel encapsulates Layer 2 frames of the Layer 2 overlay network as payloads in Layer 3 packets. The Layer 3 packets are communicated through the Layer 3 underlay network. A network in which frames of a Layer 2 overlay network are carried in a Layer 3 underlay network is referred to as an “underlay and overlay network.” A network device, such as a network switch or another type of network device that forwards data, can include a VTEP, which is a data plane entity that performs VXLAN encapsulation and decapsulation.

A role tag is added by an ingress network switch when the ingress network switch receives a data packet from a source compute entity. The ingress network switch looks up its network address mapping information (e.g., similar to 116 in FIG. 1) to determine the source role of the source compute entity. The data packet is sent by the ingress network switch to an egress network switch connected to the destination compute entity to which the data packet is targeted. The egress network switch determines the destination role of the destination compute entity. Based on the combination of the source role and the destination role, the egress network switch can apply a role-based policy.

In some examples, role-based policies are not installed in the forwarding hardware controller 114 until a role is encountered by the network switch 102A that is associated with the role-based policies. In this way, role-based policies are installed on an as-needed basis as roles are detected, which avoids wasting resources of the forwarding hardware controller 114 based on installing role-based policies for roles that have not yet been encountered by the network switch 102A. In some examples, the forwarding hardware controller 114, which may be a TCAM controller for example, may have a relatively small amount of memory space available. Installing too many policies in the forwarding hardware controller 114 may cause the memory space to run out.

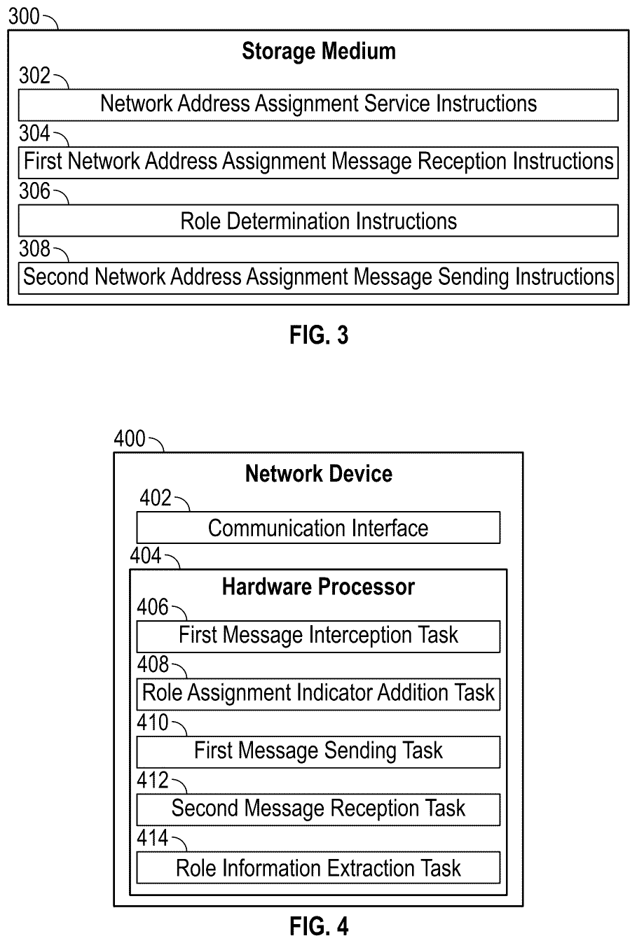

FIG. 3 is a block diagram of a non-transitory machine-readable or computer-readable storage medium 300 storing machine-readable instructions that upon execution cause a server to perform various tasks. The server may be the DHCP server 112 of FIG. 1 or another server.

The machine-readable instructions include network address assignment service instructions 302 to provide a network address assignment service for compute entities to assign network addresses to the compute entities. For example, the network address assignment service includes a DHCP service in which an IP address is dynamically assigned to a compute entity for a MAC address of the compute entity.

The machine-readable instructions include first network address assignment message reception instructions 304 to receive a first message including a role assignment indicator for a compute entity. The first message is part of a network address assignment process for the compute entity, and the role assignment indicator informs the server that the server is to assign a role to the compute entity for implementing a role-based policy. In some examples, the first message is a DHCP Discover message.

The machine-readable instructions include role determination instructions 306 to determine, based on detecting the role assignment indicator, the role of the compute entity. For example, the role determination instructions 306 can access the network address-role mapping information 126 that correlates different network addresses to respective different roles.

The machine-readable instructions include second network address assignment message sending instructions 308 to send, from the server as a response to the first message, a second message containing a role field specifying the role of the compute entity. For example, the second message can include a DHCP Offer message.

In some examples, the role assignment indicator in the DHCP Discover message includes a VCI set to a specified value, the VCI being according to DHCP option 60.

In some examples, the role field is included in vendor-specific information of the DHCP Offer message. The role field is included in TLV encoded information, and the role field in the TLV encoded information is indicated by a specified sub-option type. The TLV encoded information is a sub-option of DHCP option 43.

In some examples, the indicator is added to the first message by a network device to which the compute entity is connected for access of a network. The network device can be the network switch 102A or 102B of FIG. 1, for example.

In some examples, the server sends the second message to the network device that extracts the role field specifying the role of the compute entity from the second message.

FIG. 4 is a block diagram of a network device 400 according to some examples. The network device 400 may be a network switch or another type of network device.

The network device 400 includes a communication interface 402 to communicate with a network address assignment server, such as the DHCP server 112 of FIG. 1. The communication interface 402 includes a signal transceiver to transmit and receive signals. The communication interface 402 may further include one or more communication protocol layers that manage communications according to one or more respective communication protocols.

The network device 400 includes a hardware processor 404 (or multiple hardware processors) to perform various tasks. A hardware processor can include a microprocessor, a core of a multi-core microprocessor, a microcontroller, a programmable integrated circuit, a programmable gate array, or another hardware processing circuit. A hardware processor performing a task can refer to a single hardware processor performing the task or multiple hardware processors performing the task.

The tasks of the hardware processor 404 include a first message interception task 406 to intercept, at the network device 400, a first message associated with a network address assignment process for a compute entity. The interception of the first message can be part of DHCP snooping, for example.

The tasks of the hardware processor 404 include a role assignment indicator addition task 408 to add an indicator to the first message. The indicator informs the network address assignment server that the network address assignment server is to assign a role to the compute entity for implementing a role-based policy.

The tasks of the hardware processor 404 include a first message sending task 410 to send the first message with the indicator to the network address assignment server. In some examples, the first message may be broadcast by the network device 400, and the network address assignment server is one of multiple network address assignment servers.

The tasks of the hardware processor 404 include a second message reception task 412 to receive a second message as a response to the first message. The second message contains a role field specifying the role of the compute entity. The role of the compute entity is determined by the network address assignment server based on a network address included in the first message.

The tasks of the hardware processor 404 include a role information extraction task 414 to extract, at the network device, role information from the role field in the second message to determine the role of the compute entity.

In some examples, the network device 400 adds the role information to an entry of network address mapping information, the entry correlating the role to a network address of the compute entity. The network address mapping information can include a MAC address table or an ARP table, for example.

In some examples, the network device 400 adds a role tag to a header of a data packet from the compute entity, the role tag including the information of the role retrieved from the entry of the network address mapping information. The role tag is added by the network device 400 in response to the data packet received from the compute entity. The role tag indicates the source role of the compute entity.

In some examples, the network device 400 includes a forwarding hardware controller to forward data packets. The network device 400 dynamically installs a role-based policy corresponding to the role in the forwarding hardware controller responsive to discovering the role as part of the network address assignment process.

In some examples, the forwarding hardware controller is to enforce the role-based policy when forwarding a data packet.

In some examples, the forwarding hardware controller includes a TCAM hardware controller.

In some examples, the network device 400 removes the role field from the second message, and sends the second message without the role field to the compute entity.

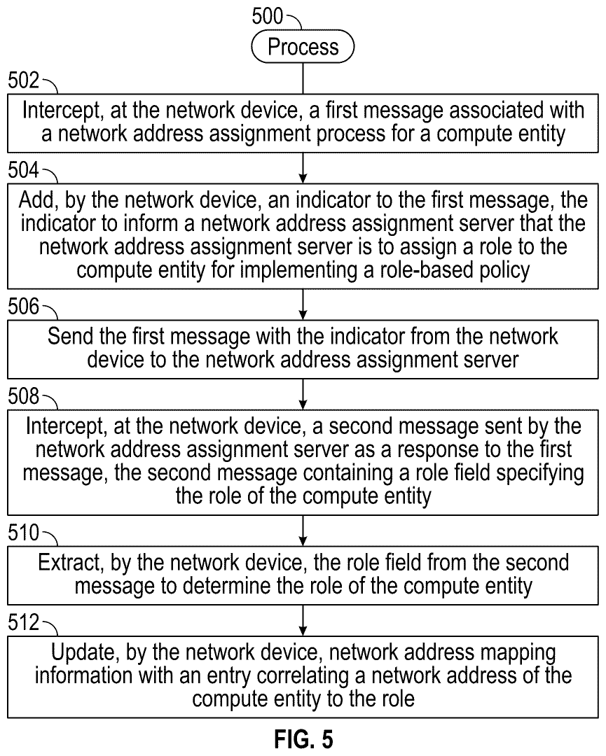

FIG. 5 is a flow diagram of a process 500 according to some examples of the present disclosure. The process 500 may be performed by a network device, such as the network switch 102A or 102B.

The process 500 includes intercepting (at 502), at the network device, a first message associated with a network address assignment process for a compute entity. The intercepting can be part of DHCP snooping in some examples.

The process 500 includes adding (at 504), by the network device, an indicator to the first message, the indicator to inform a network address assignment server that the network address assignment server is to assign a role to the compute entity for implementing a role-based policy. The role assigned by the network address assignment server can be based on a lookup of network address-role mapping information (e.g., 126 in FIG. 1).

The process 500 includes sending (at 506) the first message with the indicator from the network device to the network address assignment server. The indicator causes the network address assignment server to identify the role of the compute entity based on the network address of the compute entity.

The process 500 includes intercepting (at 508), at the network device, a second message sent by the network address assignment server as a response to the first message, the second message containing a role field specifying the role of the compute entity.

The process 500 includes extracting (at 510), by the network device, the role field from the second message to determine the role of the compute entity. The process 500 includes updating (at 512), by the network device, network address mapping information with an entry correlating a network address of the compute entity to the role.

As used here, a memory can be implemented using one or more memory devices. A memory device can include any or some combination of the following: a dynamic or static random access memory (a DRAM or SRAM) device, an erasable and programmable read-only memory (EPROM) device, an electrically erasable and programmable read-only memory (EEPROM) device, or a flash memory device.

Although FIGS. 2 and 5 show respective orders of tasks, in other examples, the tasks of a process may be performed in a different order, some tasks may be omitted, and other tasks may be added.

A storage medium (e.g., 300 in FIG. 3) can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a server to:
provide a network address assignment service for compute entities to assign network addresses to the compute entities;
receive a first message comprising an indicator for a compute entity, the first message being part of a network address assignment process for the compute entity, and the indicator informing the server that the server is to assign a role to the compute entity for implementing a role-based policy;
determine, based on detecting the indicator, the role of the compute entity; and
send, from the server as a response to the first message, a second message containing a role field specifying the role of the compute entity.

2. The non-transitory machine-readable storage medium of claim 1, wherein the server comprises a Dynamic Host Configuration Protocol (DHCP) server, and the network address assignment process comprises a DHCP process.

3. The non-transitory machine-readable storage medium of claim 2, wherein the first message comprises a DHCP Discover message, and the indicator is included in the DHCP Discover message.

4. The non-transitory machine-readable storage medium of claim 3, wherein the indicator comprises a vendor class identifier (VCI) set to a specified value, the VCI being according to DHCP option 60.

5. The non-transitory machine-readable storage medium of claim 3, wherein the second message comprises a DHCP Offer message, and the role field is included in the DHCP Offer message.

6. The non-transitory machine-readable storage medium of claim 5, wherein the role field is included in vendor-specific information of the DHCP Offer message.

7. The non-transitory machine-readable storage medium of claim 6, wherein the role field is included in Type-Length-Value (TLV) encoded information, and the role field in the TLV encoded information is indicated by a specified sub-option type, and wherein the TLV encoded information is a sub-option of DHCP option 43.

8. The non-transitory machine-readable storage medium of claim 1, wherein the indicator is added to the first message by a network device to which the compute entity is connected for access of a network.

9. The non-transitory machine-readable storage medium of claim 8, wherein the server is to send the second message to the network device that extracts role information from the role field in the second message.

10. A network device comprising:
a communication interface to communicate with a network address assignment server; and
a hardware processor to:
intercept, at the network device, a first message associated with a network address assignment process for a compute entity;
add an indicator to the first message, the indicator informing the network address assignment server that the network address assignment server is to assign a role to the compute entity for implementing a role-based policy;
send the first message with the indicator to the network address assignment server;
receive a second message as a response to the first message, the second message containing a role field specifying the role of the compute entity; and
extract, at the network device, role information from the role field in the second message to determine the role of the compute entity.

11. The network device of claim 10, wherein the hardware processor is to:
add information of the role to an entry of network address mapping information, the entry correlating the role to a network address of the compute entity.

12. The network device of claim 11, wherein the network address mapping information comprises a Media Access Control (MAC) address table or an Address Resolution Protocol (ARP) table.

13. The network device of claim 11, wherein the network device is to add a role tag to a header of a data packet from the compute entity, the role tag comprising the information of the role retrieved from the entry of the network address mapping information.

14. The network device of claim 10, further comprising:
a forwarding hardware controller to forward data packets,
wherein the hardware processor is to dynamically install the role-based policy corresponding to the role in the forwarding hardware controller responsive to discovering the role as part of the network address assignment process.

15. The network device of claim 14, wherein the forwarding hardware controller is to enforce the role-based policy when forwarding a data packet.

16. The network device of claim 14, wherein the forwarding hardware controller comprises a Ternary Content-addressable Memory (TCAM) hardware controller.

17. The network device of claim 10, wherein the hardware processor is to:
remove, at the network device, the role field from the second message; and
send, from the network device to the compute entity, the second message without the role field.

18. The network device of claim 10, wherein the first and second messages are Dynamic Host Configuration Protocol (DHCP) messages, and the network device is to perform DHCP snooping to detect the first and second messages.

19. A method comprising:
intercepting, at a network device, a first message associated with a network address assignment process for a compute entity;
adding, by the network device, an indicator to the first message, the indicator to inform a network address assignment server that the network address assignment server is to assign a role to the compute entity for implementing a role-based policy;
sending the first message with the indicator from the network device to the network address assignment server;
intercepting, at the network device, a second message sent by the network address assignment server as a response to the first message, the second message containing a role field specifying the role of the compute entity;
extracting, by the network device, the role field from the second message to determine the role of the compute entity; and
updating, by the network device, network address mapping information with an entry correlating a network address of the compute entity to the role.

20. The method of claim 19, wherein the second message further comprises an Internet Protocol (IP) address assigned to the compute entity by the network address assignment server.
